(19) United States
(12) Patent Application Publication
(10) Pub. No.: US 2019/0102730 A1
(43) Pub. Date: Apr. 4, 2019

(54) DRONE DELIVERY AND LANDING

(71) Applicants: Michael E. Giorgi, Hudson, OH (US); Patrick M. Mause, Streetsboro, OH (US); Steven Rosen, Hunting Valley, OH (US)

(72) Inventors: Michael E. Giorgi, Hudson, OH (US); Patrick M. Mause, Streetsboro, OH (US); Steven Rosen, Hunting Valley, OH (US)

(21) Appl. No.: 16/151,412

(22) Filed: Oct. 4, 2018

Related U.S. Application Data
(60) Provisional application No. 62/568,301, filed on Oct. 4, 2017.

(51) Int. Cl. G06Q 10/08; B64C 39/02; B64D 1/02; B64D 1/22; H04W 4/70; H04L 29/08

(52) U.S. Cl. CPC G06Q 10/0832; G06Q 10/0833; B64C 39/024; B64D 1/02; B64C 2201/141; H04W 4/70; H04L 67/12; B64C 2201/128; B64D 1/22

(57) ABSTRACT

Techniques that facilitate drone delivery and landing, particularly with respect to home and commercial package delivery, are provided. In one example, a computer-implemented method comprises: detecting, by a system comprising a processor, presence of a drone device within a defined vicinity of a protected area, wherein the protected area is accessible via an opening that is blocked by a physical barrier. The method further comprises controlling, by the system, access by the drone device to the protected area to drop off or pick up a package by controlling removal of the physical barrier based in part on detection of the drone device within the defined vicinity of the protected area.

### CROSS-REFERENCE TO RELATED APPLICATIONS

This application claims priority to U.S. Provisional Patent Application Ser. No. 62/568,301 filed on Oct. 4, 2017, entitled “DRONE DELIVERY AND LANDING.” The entirety of the aforementioned application is incorporated by reference herein.

### TECHNICAL FIELD

The disclosed subject matter relates to systems, computer-implemented methods, apparatus and/or computer program products that facilitate drone delivery and landing.

### BACKGROUND

Machine to machine (M2M) is a broad label that can be used to describe any technology that enables networked devices to exchange information and perform actions without the manual assistance of humans. M2M technologies can connect millions of devices within a single network. The range of connected devices includes anything from vending machines to medical equipment to vehicles to buildings. Virtually any type of electrical device that includes an on/off switch can be connected to another device via a wired or wireless network and thus has the capability of performing M2M communications, also referred to as machine type communications (MTC). M2M communication enables innovative advances in technology and can be used for many purposes in a wide range of applications, and hence can bring several benefits to industry and business. They are viewed as a key enabler of the Internet of Things (IoT) and ubiquitous applications, like mobile healthcare, telemetry, intelligent transport systems, and home automation systems.

The canonical example of the IoT is the “smart home”. There are a growing number of appliances, devices, and elements within the modern home that are going online and being accessed via smart devices. For example, the smart home components can include sensor-equipped white goods, security, lighting, heating, ventilation and entertainment devices, among others, all connected to a local server or gateway, which can be accessed by the appropriate service providers. Various home automation solutions for energy management, security, remote monitoring and control, and e-health offer various advantages and improve the way we live. The list of smart home applications is open-ended. Accordingly, new or improved home automation M2M applications that can improve quality of life for residents are in high demand.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatus and/or computer program products that facilitate drone delivery and landing.

According to an embodiment, a system is provided comprising a memory that stores computer executable components, and a processor that executes the computer executable components stored in the memory. The computer executable components can comprise a drone detection component configured to detect presence of a drone device within a defined vicinity of a protected area, wherein the protected area is accessible via an opening that is blocked by a physical barrier, and an access control component configured to control access, by the drone device to the protected area via the opening by controlling removal of the physical barrier based in part on detection of the drone device within the defined vicinity of the protected area. For example, in some implementations, the physical barrier comprises a door or gate and wherein the access control component is configured to control the access by the drone device to the protected area by controlling opening and closing of the door or gate.

According to another embodiment, a drone device is provided. The drone device can comprise a package carrying apparatus configured to carry a package, a memory that stores computer executable components, and a processor that executes the computer executable components stored in the memory. The computer executable components can comprise a navigation component configured to control flight of the drone device to a protected area, wherein the protected area is accessible via an opening that is blocked by a physical barrier. The computer executable components can further comprise an access component configured to facilitate access by the drone device to the protected area via the opening to drop off the package or pick up the package by facilitating removal of the physical barrier.

In some implementations, the access component comprises a signaling component configured to emit a notification signal indicating the drone device has the package for delivery at the protected area or indicating the drone device is scheduled to pick up the package at the protected area, wherein the drone device is configured to receive the access to the protected area via the opening based on reception of the notification signal by a management device at the protected area. With these implementations, the management device is configured to control the removal of the physical barrier based on the reception of the notification signal. In another implementation, the access component can comprise a request component configured to send an access request to a management device at the protected area requesting access to the protected area, wherein the management device is configured to control the removal and reapplication of the physical barrier based on reception of the access request. In one implementation, the access request can comprise authorization information for the drone device and wherein the management device is configured to control the removal of the physical barrier based on a determination that the authorization information is valid.

According to yet another embodiment, a computer implemented method is provided that comprises detecting, by a system comprising a processor, presence of a drone device within a defined vicinity of a protected area, wherein the protected area is accessible via an opening that is blocked by a physical barrier, and controlling, by the system, access by the drone device to the protected area to drop off or pick up a package by controlling removal of the physical barrier based in part on detection of the drone device within the defined vicinity of the protected area. In some implementations, the method can further comprise receiving, by the system, a request from the drone device to access the protected area, the request comprising authorization information for the drone device, and providing, by the system, the drone device the access to the protected area by controlling the removal of the physical barrier based on a determination that the authorization information is valid.

### DESCRIPTION OF THE DRAWINGS

FIG. 1 illustrates a block diagram of an example, non-limiting system that facilitates drone delivery and landing in accordance with one or more embodiments described herein.

FIG. 2 illustrates an example, non-limiting aerial drone device in accordance with one or more embodiments described herein.

FIG. 3 illustrates an example, non-limiting application of the subject drone delivery and landing techniques to facilitate automated home package delivery using drones in accordance with one or more embodiments described herein.

FIG. 4 illustrates a block diagram of an example, non-limiting local M2M management device that facilitates drone delivery and landing in accordance with one or more embodiments described herein.

FIG. 5 illustrates a block diagram of another example, non-limiting system that facilitates drone delivery and landing in accordance with one or more embodiments described herein.

FIG. 6 illustrates a block diagram of another example, non-limiting system that facilitates drone delivery and landing in accordance with one or more embodiments described herein.

FIG. 7 illustrates a block diagram of an example, non-limiting local M2M management device that facilitates drone delivery and landing in accordance with one or more embodiments described herein.

FIG. 8 illustrates an example, non-limiting application of the subject drone delivery and landing techniques to facilitate automated home package delivery indoors using drones in accordance with one or more embodiments described herein.

FIG. 9 illustrates a block diagram of an example, non-limiting system drone device that provides for autonomous drone delivery and landing in accordance with one or more embodiments described herein.

FIG. 10 illustrates a flow diagram of an example, non-limiting computer-implemented method that facilitates drone delivery and landing in accordance with one or more embodiments described herein.

FIG. 11 illustrates a flow diagram of another example, non-limiting computer-implemented method that facilitates drone delivery and landing in accordance with one or more embodiments described herein.

FIG. 12 illustrates a flow diagram of another example, non-limiting computer-implemented method that facilitates drone delivery and landing in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The subject disclosure is directed to systems, computer-implemented methods, apparatus and/or computer program products that facilitate drone delivery and landing, particularly with respect to home and commercial package delivery. In particular, drones are likely to play an increased role in home and commercial deliveries as the cost to operate them falls, their range extends, and the legal framework around autonomous drone operations develops. To provide superior service and to avoid packages being dropped off outside, a local M2M gateway device provided at or near the home, such as an existing M2M gateway device at or near the home that facilitates various existing smart home M2M applications, can be configured to integrate with the drones. In this regard, the local M2M gateway device can be configured to facilitate directing the drones when and where to drop off packages at or within a home, commercial building, or other suitable environment.

In one or more embodiments, the local M2M gateway device can be configured to control access by the delivery drones to protected or secure package drop off locations at or within a home, commercial building, or another suitable environment. For example, in some embodiments, a drone can be directed to drop off a package in a garage or other enclosed area of a home and the local M2M gateway device at the home can facilitate opening the garage door or a door for the enclosed area. In some implementations, the local M2M gateway device can be configured to open the door based on detection of the drone's approach. For example, the drone can be configured to transmit an authentication beacon or code that the local M2M gateway can be configured to detect and recognize, and in response, open the door. In other implementations, one or more sensors (e.g., optical, audio, motion sensing, electromagnetic, etc.) communicatively coupled to the local M2M gateway can be configured to provide sensory feedback that indicates a delivery drone is approaching the protected area, and in response the local M2M gateway device can trigger the opening of the door. In other implementations, the drone can be configured to request access when located within the vicinity of the protected drop off location and the local M2M gateway can have access to tracking information to verify the request prior to triggering the opening of the door.

In some embodiments, the local M2M gateway device can be configured to control the timing of drone access to protected drop off locations. For example, in one implementation, the local M2M gateway device can grant a drone access to a particular drop off location for a predetermined period of time (e.g., the drone has one minute to enter, deliver the package, and then exit before the door closes). In another example, the period of time can toll from when the drone arrives, when the drone device provides the correct authorization information, when the door is opened, or in response to another defined trigger event. In other examples, the drone may only be granted access to enter during a pre-established window of time (e.g., between noon and 1 pm), and any access requests outside of that time frame may not be granted.

Once access is granted, the drone can determine where to deliver the packages using one of several different methods. One method can include receiving coordinates from the local M2M gateway device and delivering the package at the coordinates. Another method can include transmission of a beacon by the local M2M gateway device or a beacon device controlled by the local M2M gateway device. The beacon can be tracked by the drone to facilitate delivering the package at or near the beacon transmit location. In another method, there can be visual markings at or near a drop off location that can be interpreted by the drone as a defined landing location. The marking can include for example, one or more standardized markings, quick response (QR) codes (or other similar barcodes), that the drones can be configured to recognize as identifiers for drop off locations. In some embodiments, the drones can not only deliver packages, but pick up packages from a protected pick up location (e.g., the garage or another suitable location). Markings on the package to be picked up and/or at or near the pick up location can signal to the drone which packages are to be picked up.

Various exemplary embodiments are described herein with reference to a drone device delivering packages, and/or picking up packages from a home or private residence. However, it should be appreciated that the disclosed drone delivery applications can be employed in various environments and contexts that involve delivering packages and/or picking up packages to/from a protected area. In this regard, the protected area can include various physical areas to which access can be blocked by a physical barrier (e.g., a door, a garage door, a window, a gate, a retractable roof, a force field, and the like) that can be autonomously removed and reapplied at the control of another machine (e.g., a local M2M gateway device communicatively coupled to the electrical and mechanical door opening/closing mechanism). For example, in addition to home package delivery, the disclosed drone delivery applications can be employed in association with delivery of packages to various types of buildings, including commercial buildings. In another example, the disclosed drone delivery techniques can be employed to deliver packages to designated package delivery structures, such as an enclosed or locked box (e.g., a mailbox, a locker, or the like), that can be autonomously opened and/or closed to by a central controller communicatively and/or electrically coupled to the locked box door, or by the drone itself.

The term “package” is used herein to refer to the object that can be delivered by a drone device. A package generally refers to an object or group of objects wrapped in paper or plastic or packed into a box. However, it should be appreciated that the disclosed drone delivery applications can be used to delivery various types of objects in various forms and are not limited to delivery packages. Although the term “drone device” is used herein, in various embodiments, the examples provided can include one or more drone devices operating independently or in a distributed fashion, as applicable. All such embodiments are envisaged.

The subject disclosure is now described with reference to the drawings, wherein like reference numerals are used to refer to like elements throughout. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

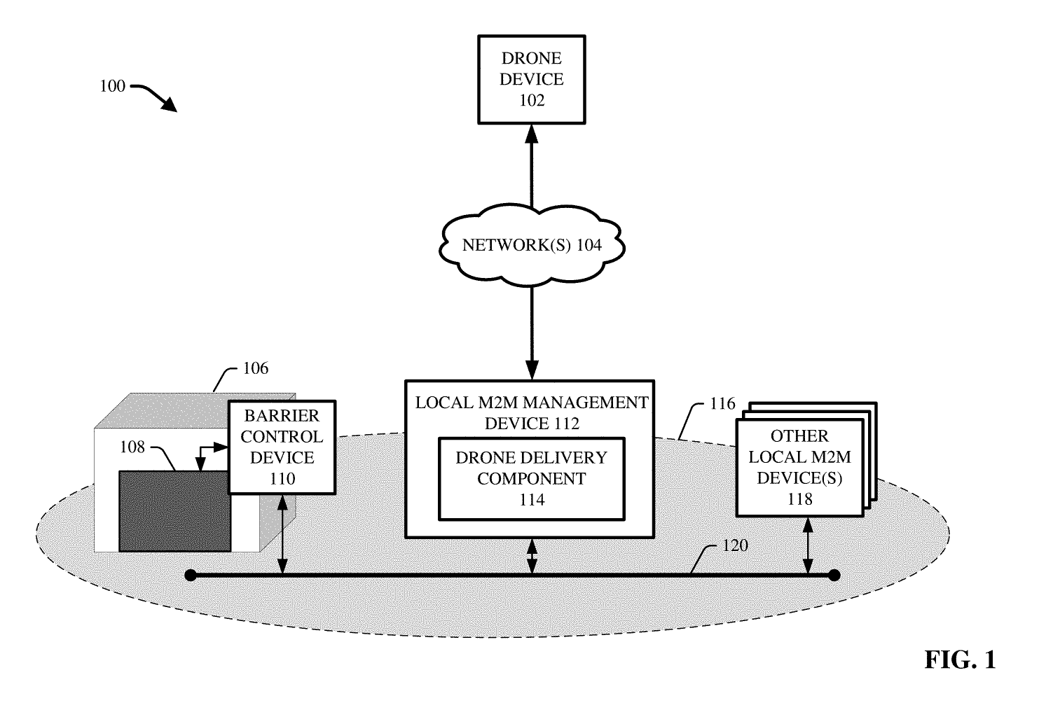

FIG. 1 illustrates a block diagram of an example, non-limiting system 100 that facilitates drone delivery and landing in accordance with one or more embodiments described herein. Aspects of the systems, apparatuses or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

System 100 includes a drone device 102, a local M2M subsystem 116, and one or more communication networks 104. The M2M subsystem 116 can comprise two or more communicatively coupled M2M devices configured to exchange information and perform one or more actions that facilitate drone delivery and landing without the manual assistance of humans. In the embodiment shown, these M2M devices can comprise at least a barrier control device 110 and a local M2M management device 112. In some implementations, the local M2M subsystem 116 can include one or more other local M2M devices 118. For example, in some implementations, the local M2M subsystem 116 can be that of a smart home and the one or more other local M2M devices can include the various connected appliances and devices of the smart home (e.g., HVAC devices, electrical blinds system devices, electrical irrigation system devices, electrical security system devices, and the like).

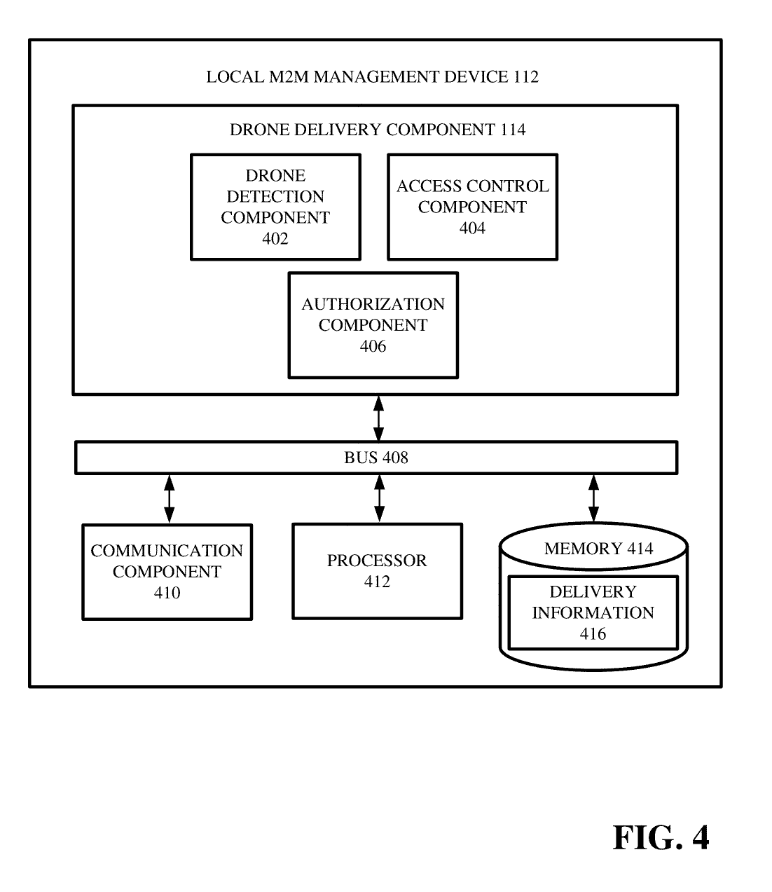

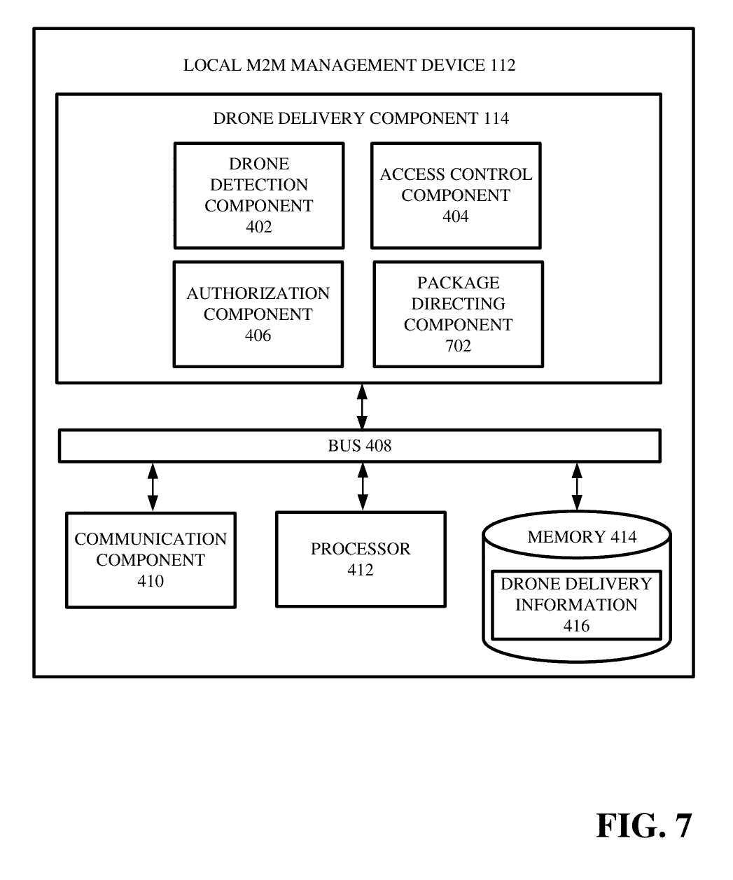

In various embodiments, the local M2M management device 112 can serve as a local gateway device that can manage and control the various operations of the M2M devices of the local M2M subsystem 116 (e.g., the barrier control device 110, and the one or more other local M2M devices 118). In particular, in accordance with one or more embodiments of the disclosed subject matter, the local M2M management device 112 can include a drone delivery component 114 can that can perform various functions that facilitate package delivery, pick up, and landing by drone devices (e.g., drone device 102) at or within a protected area 106 associated with the local M2M subsystem 116. The various features and functionalities of the drone delivery component 114 are discussed in greater detail infra with reference to FIGS. 4 and 7. The local M2M management device 112, (and the associated devices of the local M2M subsystem 116 that are connected to the M2M management device 112), can be communicatively coupled to various external devices/systems via one or more networks 104. For example, the local M2M management device 112 can be configured to communicatively couple the local M2M management subsystem 116 to the drone device 102, as well as various other devices and systems, not shown (e.g., one or more mobile user devices, application servers, and the like). The various devices and/or components of the local M2M subsystem 116 can be communicatively coupled to one another via one or more local M2M networks 120.

The one or more networks 104 and the one or more local networks 120 can include various types of networks that facilitate M2M or machine type communications (MTC). (The terms MTC and M2M are used herein interchangeably). For example, the one or more networks 104 and the one or more local networks 120 can include but are not limited to: cellular networks, femto networks, picocell networks, microcell networks, internet protocol (IP) networks Wi-Fi service networks, broadband service network, enterprise networks, cloud based networks, and the like. The devices of system 100 (e.g., the drone device 102, the barrier control device 110, the local M2M management device 112, the one or more other local M2M device 118, and the like) can employ various wireless communication technologies to facilitate wired and wireless radio communications between the devices. For example, these communication technologies can include but are not limited to: Universal Mobile Telecommunications System (UMTS) technologies, LTE technologies, advanced LTE technologies (including voice over LTE or VoLTE), narrowband IoT (NB-IoT), Code Division Multiple Access (CDMA) technologies, Time Division Multiple Access (TDMA) technologies, Orthogonal Frequency Division Multiplexing (OFDN) technologies, Filter Bank Multicarrier (FBMC) technologies, Wireless Fidelity (Wi-Fi) technologies, Worldwide Interoperability for Microwave Access (WiMAX) technologies, General Packet Radio Service (GPRS) technologies, Enhanced GPRS, technologies, Third Generation Partnership Project (3GPP) technologies, Fourth Generation Partnership Project (4GPP) technologies, Fifth Generation Partnership Project (5GPP) technologies, Ultra Mobile Broadband (UMB) technologies, High Speed Packet Access (HSPA) technologies, Evolved High Speed Packet Access (HSPA+), High-Speed Downlink Packet Access (HSDPA) technologies, High-Speed Uplink Packet Access (HSUPA) technologies, ZIGBEE® technologies, or another IEEE 802.XX technology, BLUETOOTH® technologies, BLUETOOTH® low energy (BLE) technologies, near field communication (NFC), RF4CE, WirelessHART, 6LoWPAN, Z-Wave, ANT, and the like.

The local M2M subsystem 116 can include at least one protected area 106 that can be used as a location for delivering packages, and/or picking up packages for delivery, by the drone device 102. For example, in various implementations, the protected area 106 can include an enclosed or partially enclosed structure, such as a building (e.g., a home residence or a commercial building), a designated room of the building (e.g., a garage, and entry foyer, etc.), a locker, a mailbox, an enclosed box, or the like, to which access can be blocked by a physical barrier 108 that can be removed and re-applied by another machine. For example, the physical barrier 108 can include a door, a garage door, a gate, a window, a retractable roof a force field or the like that can be physically coupled to a mechanical/electrical barrier control device 110. The mechanically/electrical barrier control device 110 can be or include a machine, device or apparatus that can mechanically remove and re-apply the physical barrier 108 in response to one or more control signals applied by another machine, such as the local M2M management device 112, and in some embodiments, the drone device 102 directly. For example, in implementations in which the physical barrier 108 comprises a garage door, the barrier control device 110 can be or include the garage door opener. According to these implementations, based in part on detection of a drone device 102 approaching the garage door to deliver or pick up a package, the local M2M management device 112 can send a control signal to the barrier control device 110 that directs or causes the barrier control device 110 to open the garage door to allow the drone device to enter and deliver and/or pick up a package. In another example in which the physical barrier 108 comprises gate, the barrier control device 110 can include the mechanical/electrical gate opening device or system.

In some embodiments, the barrier control device 110 can be or include an electrical lock system that controls application and removal of a locking device of the physical barrier 108. With these embodiments, the barrier control device 110 can be configured unlock and lock the physical barrier, such as a locked door, window, gate, or the like. In some implementations, the barrier control device 110 can also mechanically open a physical barrier in addition to unlocking and locking. In other implementations, the drone device 102 can be configured to mechanically upon and close the physical barrier after it is unlocked. For example, in one embodiment, based in part on detection of a drone device 102 approaching a door to a protected area 106 to deliver or pick up a package, the local M2M management device 112 can send a control signal to the barrier control device 110 that directs or causes the barrier control device 110 to unlock the door and further open to allow the drone to enter there through to deliver and/or pick up a package. In another embodiment, based in part on detection of a drone device 102 approaching the door to deliver or pick up a package, the local M2M management device 112 can send a control signal to the barrier control device 110 that directs or causes the barrier control device 110 to unlock the door. The drone device can then be configured to mechanically open and/or close using a suitable mechanism. For example, the drone device 102 can be configured to push the door open or the drone device can include a robotic arm that can open and close the door.

Various exemplary embodiments are discussed wherein the local M2M management device 112 issues commands to the barrier control device 110 to control the opening and closing of the physical barrier 108. These embodiments depict the local M2M management device 112 and the barrier control device 110 as separate devices and the local M2M management device 112 serving as the intermediary between the drone device 102 and the barrier control device 110. However, it should be appreciated the disclosed subject matter is not limited to this physical system architecture. For example, in some embodiments, the local M2M management device 112 can include the barrier control device 110 or vice versa. In another example, the barrier control device 110 can include one or more components of the local M2M management device 112.

In accordance with various exemplary embodiments, the drone device 102 is an aerial drone device configured to deliver and/or pick up packages via flight. However, in one or more additional embodiments, the drone device 102 can also include a terrestrial drone device, a mobile robotic device (e.g., humanoid shaped, animal shaped, and/or any other suitable shape), and/or any combination thereof. The drone device 102 can include a propulsion system appropriate for the environments in which the drone device will operate, non-limiting examples of which include one or more propellers, one or more wings, one or more motors, one or more jet engines, one or more thrusters, one or more fins, one or more wheels, one or more continuous tracks, one or more buoyancy systems, one or more transmissions, one or more drivetrains, one or more rudders, one or more trims, one or more a tails, one or more arms, one or more legs, one or more springs, one or more steering assemblies, and/or any other suitable propulsion components or systems.

The drone device 102 can include a power source, non-limiting examples of which include one or more batteries, one or more fuel cells, natural gas, compressed air, diesel fuel, gasoline, oil, propane, nuclear power system, solar power system, piezoelectric power system, and/or any other suitable power source. The drone device 102 can include one or more computers, one or more processors, one or more memories, and one or more programs. The drone device 102 can communicate via any suitable form of wireless or wired communication using a communication device. Non-limiting examples of wireless communication can include radio communication, optical communication, sonic communication, electromagnetic induction communication, and/or any other suitable wireless communication. The drone device 102 can include one or more instruments, non-limiting examples of which include a communication device, a radio frequency identification (RFID) reader, navigation device, a sensor, a camera, a video camera, a three-dimensional camera, a global positioning system (GPS) device, a motion sensor, a radar device, a temperature sensor, a light sensor, a thermal imaging device, an infrared camera, an audio sensor, an ultrasound imaging device, a light detection and ranging (LIDAR) sensor, sound navigation and ranging (SONAR) device, a microwave sensor, a chemical sensor, a radiation sensor, an electromagnetic field sensor, a pressure sensor, a spectrum analyzer, a scent sensor, a moisture sensor, a biohazard sensor, a gyroscope, an altimeter, a microscope, magnetometer, a device capable is seeing through or inside of objects, and/or any other suitable instruments. In addition, instruments can include tools, non-limiting examples of which include, a projectile launcher, a liquid sprayer, an air blower, a flame thrower, a heat projector, a cold projector, a scent projector, a chemical projector, an electric discharge device, a grasping device, a moveable and/or articulating arm, a hand, object manipulation devices, a fire extinguisher, a screwdriver, a hammer, a wrench, a welder, a saw, a knife, a pick, a prod, a vacuum device, a suction device, a sander, a laser, and/or any suitable tools to perform any task. Additionally, instruments can include one or more indicator devices, non-limiting examples of which can include, a light, a signal light, a light pattern, a display screen, an audio speaker, and/or any other suitable indicator device.

The drone device 102 can be constructed out of any suitable material appropriate for environments in which the drone device will operate. The drone device 102 can have suitable protection against an environment in which the drone device will operate, non-limiting examples of which include weather resistant, crush resistant, fire resistant, heat resistant, cold resistant, pressure resistant, impact resistant, liquid and/or solid material ingress protection, chemical resistant, corrosion resistant, shatter resistant, scratch resistant, bio-contamination resistant, electromagnetic pulse resistant, electrical shock resistant, projectile resistant, explosion resistant, and/or any other suitable resistance for an environment in which the drone device will operate.

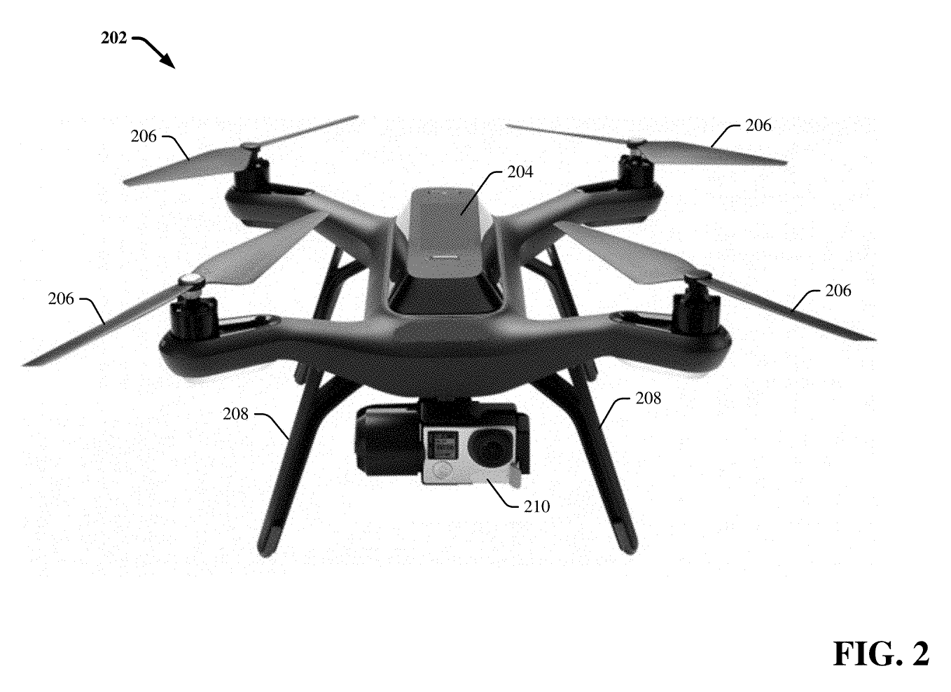

FIG. 2 illustrates a block diagram of an example, non-limiting aerial drone device 202 in accordance with one or more embodiments described herein. Drone device 202 can include a body made of a suitable material or combination of suitable materials (e.g., plastic, metal, etc.). The body 204 can house various electrical components of the drone device 202, such as a processor, memory, wireless communication circuitry, power circuitry, propulsion circuitry, and the like. The propulsion system of the drone device 202 includes four propellers 206 in a quadcopter configuration, however, it should be appreciated that the drone device 202 can include any suitable number of propellers 206 or any other suitable propulsion system. Drone device 202 can also include a camera 210 and various other suitable components (not shown), such as those disclosed herein, and/or any other suitable components that can be implemented in a drone device.

The drone device 202 can further include a package carrying apparatus 208. In the embodiment shown, the package carrying apparatus 208 can include a rail system configured to removably attach to a package or object and carry the package or object in flight. The package carrying apparatus 208 can be configured to grab or attach/detach from a package or object using a suitable attachment mechanism. For example, in some implementations, the package carrying apparatus 208 can be configured to connect to a package using one or more magnets that can be electrically activated and deactivated to couple and decouple from opposing magnets provided on or within the package. In another example, the package carrying apparatus 208 can be configured to compress and decompress so as to grab and release a package, respectively. In another example, the package carrying apparatus 208 can include one or more hooks that can latch on to a corresponding latch member on the package or object. It should be appreciated that various existing and future package carrying apparatus's and mechanisms for a drone device (e.g. drone device 202 and the like) can be employed to attach to, carry, and detach from a package or object can be employed and that the attachment mechanisms discussed above are merely exemplary. Further, it should be appreciated the drone devices described herein can be adapted to carry packages/objects of various shapes, sizes, material, and weights.

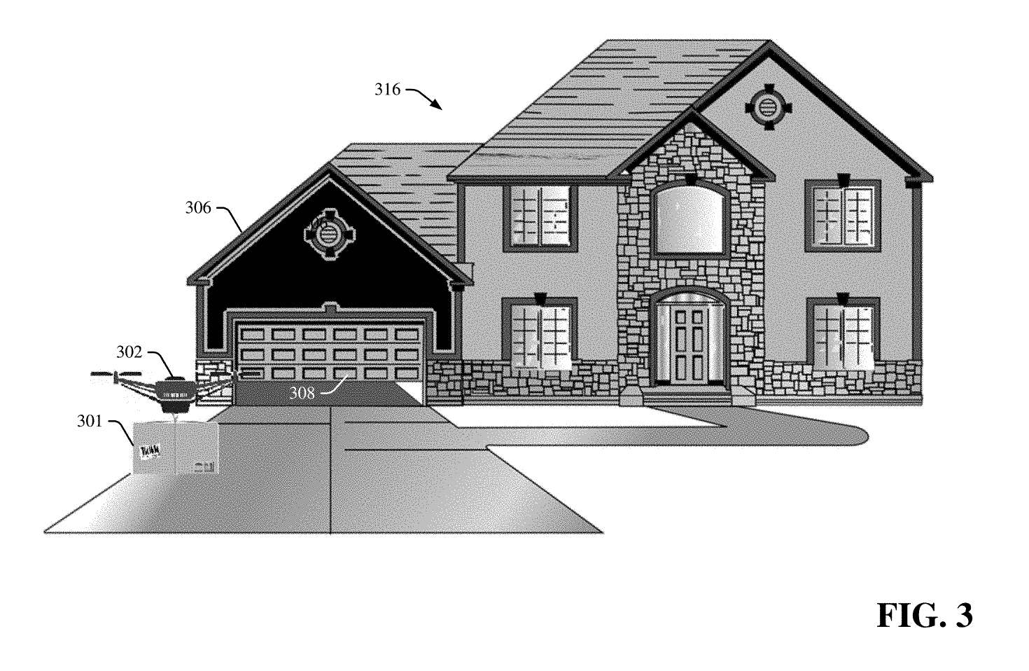

FIG. 3 illustrates an example, non-limiting application of the subject drone delivery and landing systems (e.g., system 100 and the like) to facilitate automated home package delivery using drones in accordance with one or more embodiments described herein. Repetitive description of like elements employed in other embodiments described herein is omitted for sake of brevity.

With reference to FIGS. 1 and 3, in the example shown in FIG. 3, the home residence 316 can correspond to the local M2M subsystem 116 of system 100. In this regard, the home residence 316 can be a smart home and include one or more IOT features that are either autonomously controlled, controlled by a central gateway device (e.g., local M2M management device 112) of the local M2M subsystem, and/or remotely controlled via a remote device (e.g., a client device or a server device). In accordance with the subject disclosure, the one more IOT features can include a drone delivery and landing application facilitated by the drone delivery component 114 of the local M2M management device 112. For example, the local M2M management device 112 can be provided at a suitable location on or within the home residence 316. The drone device 302 can correspond to drone device 102, the protected area 106 can correspond to the garage 306 and the physical barrier 108 can correspond to garage door. In the embodiment shown, the drone device 302 is carrying a package 301 as it is approaching the garage 306 of a home residence 316. The garage door 308 is in the process of opening to let the drone device 302 inside of the garage 306 to drop of the package 301. In one example implementation, the local M2M management device 112 caused the garage door 308 to open based in part on detection of the arrival of the drone device 302. For example, based on detecting the arrival of the drone device, the local M2M management device 112 can have issued a control command to the garage door opener (e.g., corresponding to the barrier control device 110) directing the garage door to open, thereby causing the garage door to open. In some implementations, the local M2M management device 112 can further direct the garage door opener to close the garage door once the drone device 302 has delivered the package 301 and exited the garage 306.

Although the example depicted in FIG. 3 demonstrates entry and exit of a drone device through a garage door 308 to provide for delivering packages into a home owner's garage, it should be appreciated that various additional or alternative physical barriers and associated protected areas can be employed to facilitate autonomous drone delivery. For example, in some implementations, the user's mailbox, front door, back door, second story window, and the like can be designated as possible delivery locations and electrically opened and closed at the control of the local M2M management device 112. Such alternative delivery areas may be appropriate depending on the size and shape of the package and/or the type/sensitivity of the contents of the package being delivered. For example, if a drone device is delivering a package that can fit through a small window, the M2M management device 112 can be configured to direct the drone device to enter through a second story window of the house so as to limit the possibility of an unwanted intruder entering the house via the ground floor. On the other hand, if a drone device is delivering mail considered to be of low sensitivity, the drone device 102 can be directed to deliver the mail to mailbox that is electrically opened and closed by a barrier control device 110 at the direction of the local M2M management device 112.

In other embodiments, rather than entering the delivery drop off location, the drone device 102 can be configured to drop or lower (via a pulley system or another suitable mechanical lowing system) a package into the drop off location from above. In this regard, some protected areas 106 and associated physical barriers 108 can be specifically adapted or tailored to enhance the security associated with home deliveries so as to prevent unwanted intruders from entering the home when the physical barrier is removed. For example, a designated opening for drone deliveries can be provided on the roof of a home or building to allow for the drone device to easily place a package therein while minimizing the possibility of an intruder climbing to the roof and accessing the package or the home via the opening.

FIG. 4 illustrates a block diagram of an example, non-limiting local M2M management device 114 that facilitates drone delivery and landing in accordance with one or more embodiments described herein. Repetitive description of like elements employed in other embodiments described herein is omitted for sake of brevity.

In the embodiment shown, the drone delivery component 114 of the local M2M management device 112 can include a drone detection component 402, an access control component 404 and an authorization component 406. The local M2M management device 112 can further include a communication component 410, a processor 412 and a memory 414. The memory 414 can be configured to store computer executable components and instructions (e.g., the drone delivery component 114 and associated sub-components) and the processor 412 can be configured to facilitate operation of the computer executable components and instructions by the local M2M management device 112. In some implementations, the memory 414 can also store delivery information 416 that can be employed by the drone delivery component 114 to facilitate drone delivery and landing in accordance with various aspects and embodiments described herein. The local M2M management device 112 can further include a device bus 408 that couples the various components of the local M2M management device 112, including but not limited to, the drone delivery component 114, the communication component 410, the processor 412 and the memory 414.

With reference to FIGS. 1 and 4, the communication component 410 can be configured to facilitate wired and wireless communication (e.g., MTC) between local the M2M management device 112, the drone device 102, the barrier control device 110, and various other internal M2M devices (e.g., the one or more other local M2M devices 118), as well as various other devices (e.g., external client devices, application servers, and the like). The communication component 410 can include software, hardware, or a combination of software and hardware that is configured to facilitate such wired and/or wireless communications. For example, the communication component 410 can be configured to control operation of a transmitter/receiver (or transceiver) of the local M2M management device 112 to facilitate establishing a telemetry connection or M2M link with a drone device 102 and/or the barrier control device 110. The communication component 410 can be configured to facilitate wireless communication between the local M2M management device 112 and other devices of system 100 using the various types of wireless communication systems and technologies described herein.

The drone delivery component 114 can provide various functionalities associated with facilitating drone delivery and landing in secure, designated package delivery areas, such as protected area 106. In some embodiments, the drone delivery component 114 can be configured to facilitate providing a drone access to a protected area 106 based on detection of the arrival of the drone at the protected area 106. In accordance with these embodiments, the drone delivery component 114 can include the drone detection component 402 to facilitate detecting the arrival of a drone with the intent to either drop off or pick up a package in the protected area. The drone detection component 402 can employ various mechanisms to detect the arrival of a drone device (e.g., drone device 102 and the like) to a protected area 106. In some embodiments, the drone detection component 402 can be configured to detect the arrival of a drone device based on monitored signals or beacons emitted by the drone device 102. For example, the drone device 102 can be configured to emit (e.g., regularly, periodically, when located within the vicinity of a delivery location, etc.) a signal (e.g., a radio frequency (RF) signal, a visual signal, an acoustic signal, an electromagnetic resonance signal, etc.) that indicates the presence of the drone device 102. The drone detection component 402 can be configured to listen for and monitor reception of the signal by the communication component 410 to determine where the drone is located relative to the protected area. In some implementations, the drone detection component 402 can also determine the direction of movement of the drone device 102, the speed of movement of the drone device 102 and the like based on the intensity of the received signal or beacon.

In some implementations, the signal emitted by the drone device 102 can carry information associated with the drone device 102 and/or the delivery. For example, the information can include but is not limited to, information identifying the drone device (e.g., a unique identifier for the drone device 102), and/or delivery information associated with a package to be delivered or picked up by the drone device, including but not limited to: an identifier for the package, a tracking number for the delivery, a delivery location identifier, a recipient identifier, and the like. In other implementations, the drone device 102 can provide the drone delivery component 114 with one or more messages including this kind of information in addition to the tracking signal or beacon emitted by the drone device. For example, the drone device 102 can provide the drone delivery component 114 with such information in response to a request from drone delivery component 114 or in association with a request to access the protected area 106 provided by the drone device 102.

For example, in other embodiment, the drone detection component 402 can be configured to detect the presence of a drone device 102 in response to a reception of a request from the drone device 102 to enter the protected area 106. For example, the drone device 102 can be configured to autonomously navigate to a designated protected delivery area to deliver or pick up a package. As the drone device approaches the protected area 106 or is otherwise within a defined distance relative to the protected area, the drone device 102 can be configured to send the local M2M management device 112 a request to access the protected area 106. According to this embodiment, the drone delivery component 114 can be configured to provide the drone device access to the protected area based on reception of the request.

In some embodiments, the drone detection component 402 can employ one or more sensor devices to facilitate detecting the approach of a drone device 102 toward the protected area 106 for the purpose of delivering and/or picking up a package for delivery. For example, the one or more sensor devices can include but are not limited to: optical devices (e.g., cameras, video cameras, etc.), acoustic sensors devices, motion sensor devices, electromagnetic motion sensing devices, and the like. The one or more sensor devices can be provided with the local M2M management device 112 and/or communicatively coupled to the local M2M management device 112 via the one or more local networks 120 and configured to provide captured sensory feedback to the drone detection component 402. Based on received image data, acoustic data, motion data, electromagnetic data, and the like, the drone detection component 402 can determine information regarding a position of drone device relative to the protected area, a direction of travel of the drone device, distinguishing characteristics of the drone device (e.g., type, flight purpose, etc.) and the like.

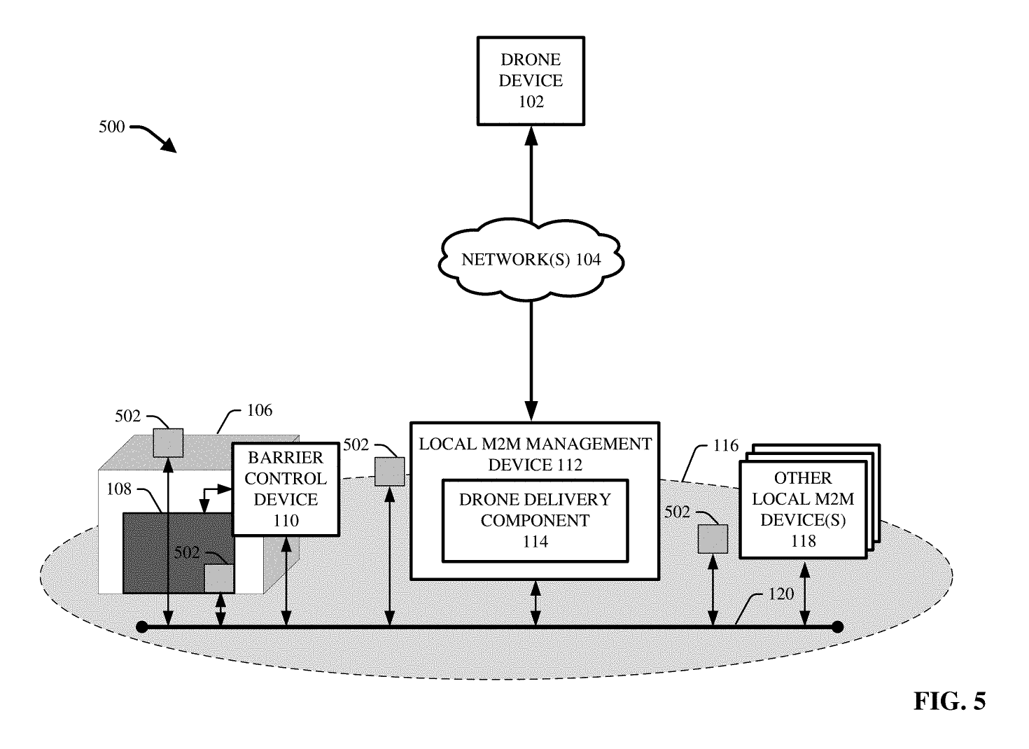

For example, FIG. 5 illustrates a block diagram of another example, non-limiting system 500 that facilitates drone delivery and landing in accordance with one or more embodiments described herein. System 500 can include same or similar components as system 100 with the addition of sensor devices 502 at various locations about the local M2M subsystem 116. The location, number and type of the sensor devices can vary based on the features of the local M2M subsystem, the protected area 106 designated as the package delivery/pick up location, the types of commodities being transported, and the like. For example, with respect to a home residence with a garage as employed as the designated protected delivery area (e.g. protected area 106), the sensor devices can include one or more cameras, motion sensors, acoustic sensors, and the like located on or near the roof of the residence, at the peripheral of the property, on or near the protected area, and the like. Repetitive description of like elements employed in other embodiments described herein is omitted for sake of brevity.

With reference back to FIGS. 1 and 4, in some embodiments, based on received image data and/or video data captured via one or more cameras (e.g., one or more sensor devices 502) located near a protected area, the drone detection component 402 can analyze the image data to determine a relative location of a drone device 102 to the protected area. Using various image tracking analysis techniques, the drone detection component 402 can also determine information regarding the direction and speed of movement of the drone device 102. In some implementation, the image data can be accompanied with depth or distance information that can assist the drone detection component 402 with determining the relative location of a drone device to a protected area 106. In addition to position and direction/speed of travel information, the drone detection component 402 can also evaluate the image data to identify distinguishable characteristics about the drone device, such as a type of the drone device (e.g., whether the drown device is a delivery drone or a drone used for other purposes), whether the drown is carrying a package, and in some implementations, a visual identifier for the drone (e.g., a unique identifier, an identifier that indicates the type of drone or manufacturer of the drone, etc.).

In one or more additional embodiments, the drone detection component 402 can receive positioning information regarding the position and direction of travel of the drone relative to a protected area 106 from an external location tracking system. In this regard, the local M2M management device 112 can be communicatively coupled to the external tracking system via one or more networks 104. The external location tracking system can employ various location monitoring techniques (e.g., global positioning system based locating techniques, radar based techniques, and the like) to track the location of drone devices (e.g., drone device 102 and the like) in real-time. In some implementations, if the external location tracking system identifies a drone device 102, (or more specifically, a drone device with a delivery or pick up scheduled for the protected area 106), the external tracking system can send a notification to the drone detection component 402 identifying the drone device and/or providing information indicating the position of the drone device relative to the protected area, a predicted arrival time of the drone at the predicted area, and the like. In other implementations, the drone detection component 402 can regularly or continuously access the real-time drone tracking information gathered by the external tracking system to determine information regarding drone device approaching the protected area.

The access control component 404 can be configured to control access of a drone device to a protected area 106 to deliver or pick up a package at the protected area. In this regard, the access control component 404 can execute or otherwise issue control signals to the barrier control device 110 that control the removal and re-application of a physical barrier 108 that blocks an opening to the protected area 106 through which the drone device 102 can pass and/or into which the drone device 102 can drop or lower a package while remaining outside of the protected area 106. For example, with respect to a physical barrier that is a door or the like, the barrier control device 110 can determine whether and when to open and close the door and further control the opening and the closing of the door by commanding the barrier control device to open and close the door, respectively (and/or unlock or lock the door in some implementations).

In some embodiments, the access control component 404 can be configured to automatically direct the barrier control device 110 to open or remove the physical barrier 108 and provide the drone device 102 with access to the protected area 106 in response to detection of a drone device within a defined vicinity or distance of the protected area 106. However, in various additional embodiments, to enhance the security associated with automated package delivery and pick up via drones, the access control component 404 can employ one or more additional techniques to determine whether and when to allow a drown device access to a protected area 106. For example, in implementations in which the access control component 404 is configured to allow any drone device within the vicinity of a protected area 106 to access to the protected area, there is a possibility that unauthorized drone devices may receive access to the protected area and the contents therein. In addition, in some scenarios, authorized drone devices may receive access to a protected area 106 to deliver unwanted packages or pick up packages intended for pick up by a different drone device. Further, when the protected area 106 is easily accessible by humans, the protected area 106 can become exposed to unwanted intruders. Accordingly, the access control component 404 can employ one or more additional techniques or protocols that provide a higher level of scrutiny before allowing a drone device 102 to access a protected area.

In some embodiments, the access control component 404 can also employ information (e.g., determined by the drone detection component 402) regarding the direction of travel of detected drone device 102, information regarding whether the drone device 102 is carrying a package for delivery, whether the drone device is recognizable as being a delivery drone (e.g., based on the appearance of the drone, markings on the drone, the size of the drone, the sound of the drone, etc.), and the like to further facilitate determining whether a drone device within the vicinity of the protected area is intending to access the protected area 106 to drop off and/or pick up a package prior to removing the physical barrier 108 and allowing the drone device 102 to access the protected area. For example, based on a determination that a drone within the vicinity of a protected area 106 is heading in the direction of the protected area, the drone device is carrying a package, and/or the drone device is recognized as a delivery drone (e.g., as opposed to drones used for other purposes), the access control component 404 can direct the barrier control device 110 to open or remove the physical barrier 108 and allow the drone to enter.

Further, in some embodiments, the access control component 404 can access delivery information 416 associated with the protected area 106 to further facilitate determine whether and when to allow a drone device to access a protected area 106. For example, in some implementations, the delivery information 416 can include package tracking information that indicates if the protected area 106 is scheduled for a package drop off or pick up prior to providing a drone device access to the protected area 106. In some implementations, the delivery information 416 can also include information regarding a scheduled date/time or time window a package is scheduled to be dropped-off or picked-up at the protected area 106. With these implementations, if the access control component 404 determines that the protected area 106 is not scheduled to receive a package delivery or pick up at the current date and/or time, the access control component 404 can restrict access of a detected drone device 102 to the protected area and direct the barrier control device 110 to keep the physical barrier closed or otherwise intact.

In the embodiment shown, the delivery information 416 is stored locally in the memory 414 of the local M2M management device. However, in other embodiments, the delivery information 416 can be provided by an external system that is responsible for providing and/or managing the drone delivery service.

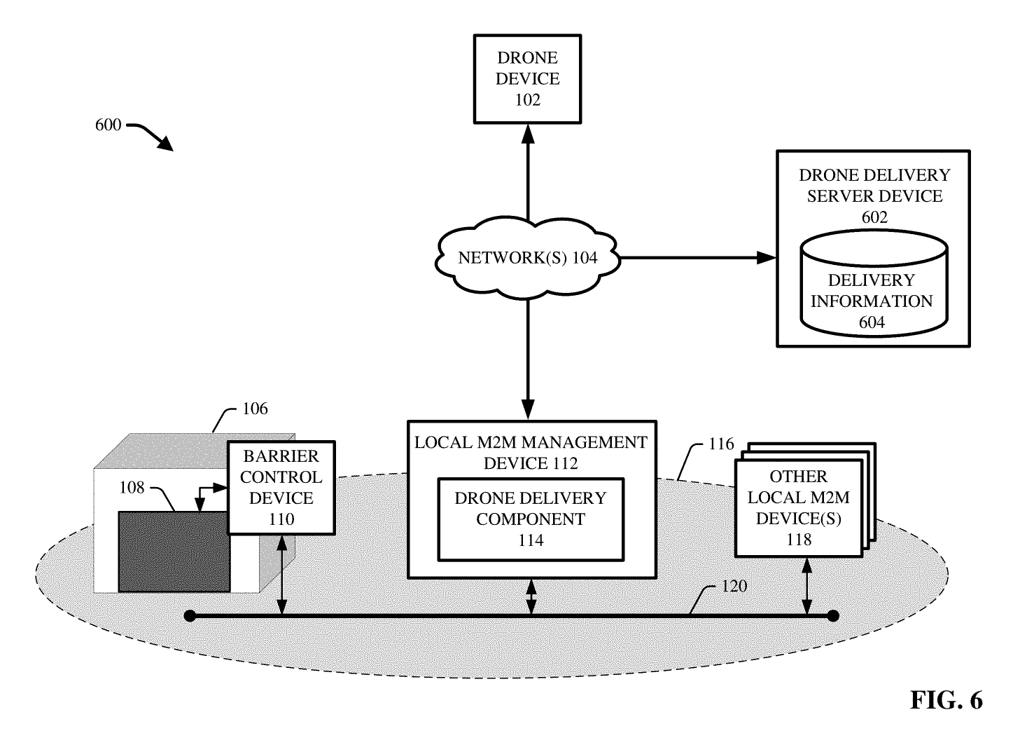

For example, FIG. 6 illustrates a block diagram of another example, non-limiting system 600 that facilitates drone delivery and landing in accordance with one or more embodiments described herein. System 600 can include same or similar components of system 100 with the addition of the drone delivery server device 602. In various embodiments, the drone delivery server device 602 can be configured to facilitate a drone based delivery and pick up service including similar features and functionalities of existing ground based package delivery organization. The drone delivery server device 602 can store delivery information 604 for deliveries and/or pick ups at designated, protected areas 106 (e.g., known address or coordinate locations for protected areas designated as package drop off/pick up locations). For example, the delivery information 604 provided at the drone delivery server device 602 can include information pertaining to all scheduled deliveries, pick and pick ups by various drone devices at various locations while the delivery information 416 stored locally at the local M2M management device 112 can include delivery information relevant to deliveries and pick ups at the particular protected location 106 controlled by the local M2M management device 112. According to these embodiments, the access control component 404 can be configured to access, review and/or retrieve the relevant delivery information 416 from delivery information 604 at the drone delivery server device 602 prior to allowing a drone device access to the protected area 106 to deliver or pick up a package.

With reference back to FIGS. 1, 4, and 6, to provide an additional layer of security, in some embodiments, the local M2M management device 404 employ an authorization procedure, facilitated by the authorization component 406, that involves determining whether a particular drone device 102 is authorized to access a protected area 106 prior to allowing access. The access control component 404 can further be configured to allow a detected drone device access to the protected area 106 based on the drone device being an authorized device. Likewise, if the drone device is an unauthorized device, the access control component 404 can deny access and instruct the barrier control device 110 to keep the physical barrier closed or otherwise in place.

In some implementations, the authorization component 406 can be configured to access authorization information that identifies or indicates one or more drone devices that are authorized to access a protected area 106. This authorization information can be stored locally in memory 414 and/or stored at the drone delivery server device 602. In one embodiment, the authorization information can include unique identifiers for the one or more drone devices that are authorized to access a protected area 106. In association with detection of a drone device 102 approaching the protected area, the authorization component 406 can be configure to determine the unique identifier assigned to the detected drone device and further compare the unique identifier with the authorization information to determine whether the detected drone device is an authorized device. For example, in some implementations, the drone detection component 402 can determine the unique identifier for a detected drone device based on inclusion of the identifier in the signal or beacon emitted by the drone device 102. In other implementations in which the drone device 102 is configured request access upon arrival at the protected area, the drone device can include the unique identifier in the request.

In another embodiment, authorized drone devices can share a secret key or password with the authorization component 406. With this embodiment, prior to providing a drone device 102 access to a protected area, the authorization component 406 can require the drone device 102 to provide it with the secret key. If the drone device cannot provide the correct secret key or password, the authorization component 406 can deny the drone device access to the protected area. In some embodiments, in association with dispatch of a drone device to a protected area 106 to drop off or pick up a package, the drone delivery server device 602 can generate and provide the drone device with a unique identifier, a secret authorization code or the like, for the pick up or delivery event. The authorization component 406 can further access the unique identifier for the pick or delivery event at the drone delivery server device 602 or otherwise be provided with this authorization information. For example, the delivery information 416 can include the unique identifier or authorization code generated for a particular drop off or pick up scheduled for the protected area. According to these embodiments, prior to allowing a detected drone device 102 access to a protected area 106, the authorization component 406 can require the drone device 102 to provide the unique identifier. The authorization component can further only allow the access control component 404 to provide the detected drone device 102 access to the protected area 106 if the unique identifier provided by the drone device matches that the unique identifier included in the delivery information 416 for the protected area 106. In some embodiments, after the delivery or pick up event is completed, the unique identifier can expire or otherwise not longer be employed by the drone device 102 to receive access to the protected area.

In addition to controlling the opening or removal of the physical barrier 108 to allow a drone device 102 to access a protected area 106 to drop off or pick up a package, the access control component 404 can also control closing or re-application of the physical barrier 108 after an authorized drone device has left the protected area 106. In some embodiments, the access control component 404 can be configured to automatically direct the barrier control device 110 to close or re-apply the physical barrier 108 in response to a determination that the drone has exited the protected area 106. In this regard, in addition to detecting the arrival of a drone at or near a protected area 106, the drone detection component 402 can also employ various techniques to determine if and when a drone device has exited the protected area. For example, the drone detection component 402 can be configured to receive feedback from one or more sensor devices (e.g., one or more cameras, motion sensors, acoustic sensors, etc.), that can be used to determine when a drone device has exited a protected area or otherwise completed a package drop off and exited the protected area 106. In another example, the drone detection component 402 can receive feedback provided by the drone device itself that indicates when the drone device has exited the protected area. For instance, the drone device 102 can be configured to provide the drone detection component 402 with a confirmation message post delivery or pickup when the drone has exited the protected area 106.

In other embodiments, the access control component 404 can be configured to leave a protected area open or otherwise accessible for a defined window of time following removal of the physical barrier 108. In this regard, the access control component 404 can grant access to the drone device for a predetermined period of time. Upon expiration of the period of time, the access control component 404 can be configured to direct the barrier control device 110 to re-apply the physical barrier 108. For example, the period of time can toll from when the physical barrier is removed 108 (e.g., the drone has 1 minute to enter, deliver the package, and then exit before the garage door closes). In some implementations, the duration of time can vary based on the package being delivered (e.g., a size of the package, a characteristic of the contents of the package such being fragile, explosive, etc., and the like). For example, if a package is fragile and large, the drone device may need more time to drop off and/or pick up. According to these implementations, the delivery information 416 can include information regarding the contents of a package being delivered or picked-up (e.g., information identifying the contents and/or characteristics of the contents such as fragile, sensitive, etc.), a size of the package, and the like and associated durations of time allowed for the drone device 102 to deliver the package.

FIG. 7 illustrates a block diagram of an example, non-limiting local M2M management device 114 that facilitates drone delivery and landing in accordance with one or more embodiments described herein. Repetitive description of like elements employed in other embodiments described herein is omitted for sake of brevity.

In the embodiment shown, the drone delivery component 114 further includes a package directing component 702. With reference to FIGS. 1 and 7, in embodiments in which the drone device 102 is configured to fully enter the protected area 106 (e.g., as opposed to dropping or lowing a package into the protected area 106), the package directing component 702 can be configured to facilitate directing the drone device 102 to a designated package drop off location or pick up location. For example, in one implementation in which the drone device 102 enters into a building to deliver or pick up a package, the package directing component 702 can be configured to direct the drone device to a particular room, table, shelf, location in the room or the like to drop off or pick up a package. In some embodiments, the package directing component 702 can have access to predefined information (e.g., included with the drone delivery information) that identifies where a package should be placed or picked up within a protected area 106. For example, the predefined information can include a defined coordinate position within the protected 106 identifying the drop off or pick up location. The package directing component 702 can be configured to provide the drone device 102 with the coordinate position information and the drone device 102 can be configured to fly or otherwise position itself at the coordinate position. In another example, the package directing component 702 can provide the drone device with a flight path or map to the designated drop off or pick up location that can be followed by the drone device 102.

In another embodiment, the system can include a beacon device at or near a designated package drop off or pick up location that is communicatively coupled to the local M2M gateway device 114. For example, the one or more other local M2M devices 118 can be or include the beacon device. The beacon device can be configured to emit a defined package localization signal or beacon that can be tracked by the drone device 102 and interpreted by the drone device 102 as marking the designated package drop off or pick up location. According to this embodiment, once the drone device 102 has entered the protected area 106, the package directing component 702 can be configured to issue a command to the beacon device to activate the beacon device can cause the beacon device to begin emitting the package localization signal or beacon. The drone device 102 can further track and navigate to the beacon device and the associated designated package drop off or pick up location based on reception of the package localization beacon. In some implementations, after the drone device has exited the protected area 106, the package directing component 702 can be configured to deactivate the beacon device.

In other embodiments, the drone device 102 can be configured to determine where to drop off a package or find a package for pick up once within a protected area 106 based on one or more visual indicators or marking provided within the protected area 106 and/or on or near a package to be picked up. For example, the protected area 106 can include visual indicators or markings on the wall, the floor, a shelf, or the like that the drone device 102 can be configured to interpret as identifying a package drop off or pick up location. The visual indicators or markings can include but are not limited to, standardized markings, QR codes, barcodes, images, symbols, patterns and the like. Once inside the protected area 106, the drone device 102 can be configured to look for the markings or visual indicators (e.g., using one or more cameras of the drone device) to determine where to land and drop off or pick up a package. In some implementations, markings on either the package to be picked up or on a mat can signal to the drone device 102 which packages are to be picked up.

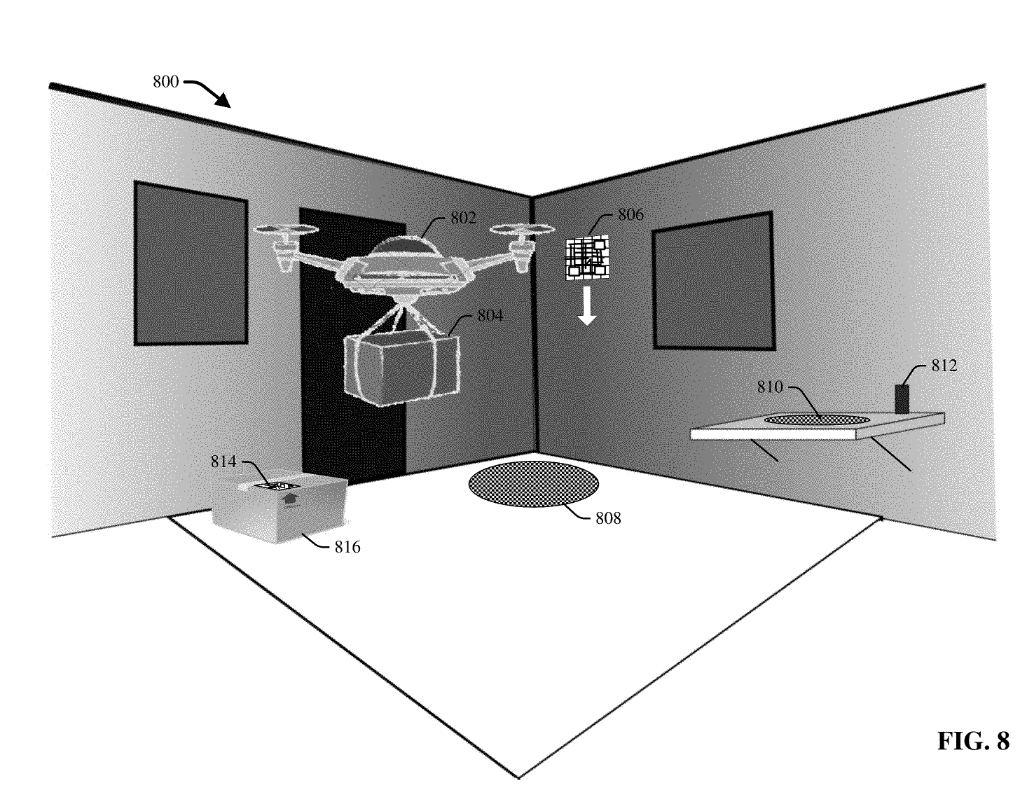

FIG. 8 illustrates an example, non-limiting application of the subject drone delivery and landing techniques to facilitate automated home package delivery indoors using drones in accordance with one or more embodiments described herein. Repetitive description of like elements employed in other embodiments described herein is omitted for sake of brevity.

In the embodiment shown, a drone device 802 carrying a package for delivery inside a protected area 800 has entered into the protected area 800. For example, the protected area 800 depicted can be the garage of a house or another room inside of a building. The inside of the protected area 800 includes various example features that can facilitate directing the drone device 802 to a designated location for dropping off the package 804. For example, a QR code 806 can be provided on a wall within the protected area that can be scanned or otherwise read by drone device 802 using a camera of the drone device 802. The QR code 806 can provide the drone device 802 with information indicating the area on the floor below the QR code 806 is a designated package drop off location. In another example, the area of the floor below the QR code 806 (or a mat on the floor) can include a visual pattern 808 that can be recognized by the drone device 802 as corresponding to a designated package drop off location. In another example, a visual pattern 810 can be provided on a shelf within the protected area 800 that can be recognized by the drone device 802 as corresponding to a designated package drop off location. In another example, a beacon device 812 can be provided at or near a designated package drop off location, which in this instance is the shelf. The beacon device 812 can be configured to emit a signal that can be recognized by the drone device 802 as marking a drop off location. With this example, the done device 802 can be configured to track the signal emitted by the beacon device 812 to fly to the beacon device 812 and drop of the package 804 on the shelf where the beacon device 812 is located.

The protected area 800 also includes a package 816 that has been left for pick up by the drone device 802. In various embodiments, based on identification of a packaged intended for pick up by the drone device 802 within a protected area, the drone device 802 can be configured to pick up the package and take it to a designated destination. The drone device 802 can employ various techniques to identify a package intended for pick up by the drone device 802 within a protected area 800. For example, in some implementations, the drone device 802 can be configured to use visual recognition to identify objects corresponding to packages within a protected area that were located within the protected area prior to arrival by the drone device 802. According to this example, based on recognition of a package, the drone device 802 can be configured to pick it up and take the package to a defined destination location. In another example, packages intended for pick up by a drone device 802 can be associated with a visual indicator that identifies the package as an intended package for pick up. For example, the visual indicator can be provided on the package itself or associated with an area at which the package is located. In the embodiment shown, the package 816 includes a label 814 provided thereon with a QR code. In accordance with this embodiment, the QR code can comprise information identifying the package 816 as a designated package for pick up. The QR code can also include additional information that can be extracted by the drone device 802 that can facilitate delivering the package to the appropriate destination (e.g., a destination address, a delivery number identifier, a tracking number, an access code for delivering the package to another protected area, etc.).

In one or more embodiments, in association with accessing the protected area 800, the done device 802 can be provided with information (e.g., by the done delivery server device 602, the local M2M management device 112, and the like) instructing the drone device 802 to pick up a package at the protected area 800 for delivery to another location. For example, prior to entry into a protected area 800 and/or in association with receiving entry into the protected area 800, the drone device 802 can be instructed to pick up a package at the protected area 800 for delivery to another location. Accordingly, when the drone device enters the protected area 800, the drone device 802 can be configured to look for the package 816 designated for pick up. In some implementations, the drone device can be provided with information (e.g., by the done delivery server device 602, the local M2M management device 112, and the like) that facilitates directing the drone device 802 to the package 816 for pick up. For example, the drone device 802 can be provided with information identifying a visual indicator (e.g., a pattern, a QR code, a symbol, etc.) to look for that marks a package designated for pick up. In another example, the drone device can be directed to a package for pick up another beacon device located on or near the package 816.

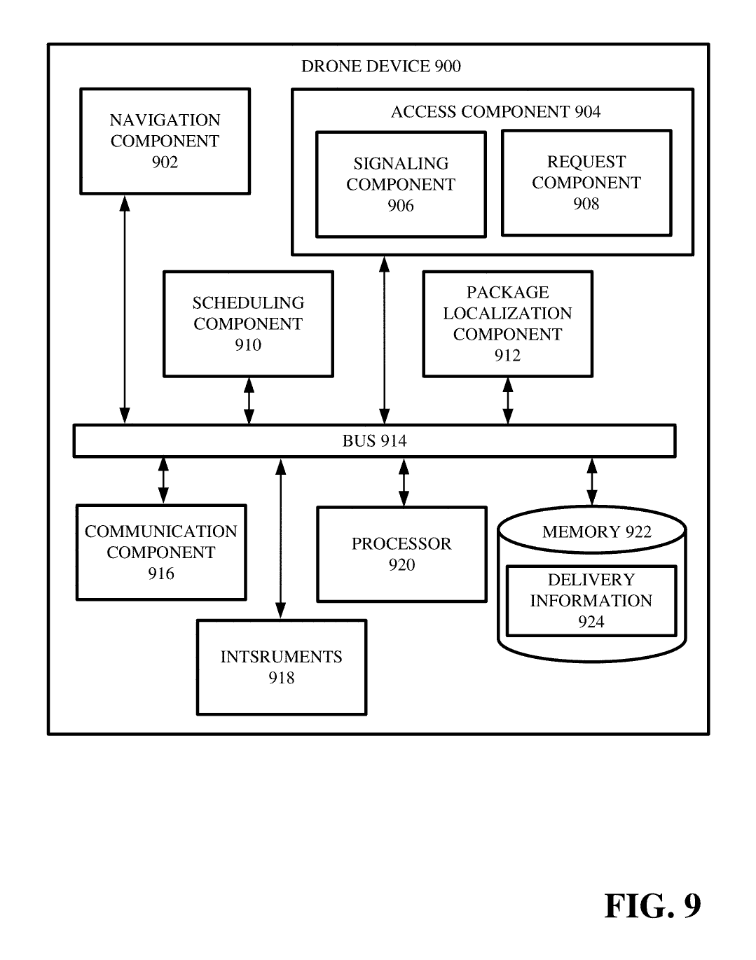

FIG. 9 illustrates a block diagram of an example, non-limiting drone device 900 that provides for autonomous package delivery and landing in accordance with one or more embodiments described herein. Drone device 900 can include the structure and/or functionality of one or more of drone devices described herein (e.g., drone devices 102, 202, 302, and 802) and vice versa. Repetitive description of like elements employed in respective embodiments is omitted for sake of brevity.

The drone device 900 can include at least one memory 922 to store computer executable components and instructions and at least one processor 920 to facilitate operation of the computer executable components and instructions by the drone device 900. In the embodiment shown, these computer executable components can include include navigation component 902, access component 904, scheduling component 910, and package localization component 912. In some implementations, the memory 922 can also store delivery information 924 that can be employed by the drone device to facilitate package delivery, pick up and landing in accordance with various aspects and embodiments described herein. The drone device 900 can also include communication component 916 to facilitate wired and wireless communications between the drone device 900 and external devices, such as but not limited to, the local M2M management device 112, the drone delivery server device 602, the barrier control device 110 in some implementations, other drone devices (not shown), one or more client devices (not shown), and the like). The communication component 916 can include same or similar features and functionalities as communication component 410.

The drone device 900 can also include various additional types of hardware and software that can be employed by the drone device 900 to facilitate various operations of the drone device. The additional hardware and/or software are collectively represented in FIG. 9 as instruments 918. For example, the instruments 918 can include but are not limited to, an RFID reader, a navigation device, a sensor, a camera, a video camera, a three-dimensional camera, a GPS device, a motion sensor, a radar device, a temperature sensor, a light sensor, a thermal imaging device, an infrared camera, an audio sensor, an ultrasound imaging device, a LIDAR sensor, sound SONAR device, a microwave sensor, a chemical sensor, a radiation sensor, an electromagnetic field sensor, a pressure sensor, a spectrum analyzer, a scent sensor, a moisture sensor, a biohazard sensor, a gyroscope, an altimeter, a microscope, magnetometer, a device capable is seeing through or inside of objects, and/or any other suitable instruments. In addition, the instruments 918 can include tools, non-limiting examples of which include, a package carrying apparatus (which can be configured to pick up, carry and drop off packages of various shapes, sizes and weights), a robotic arm, a projectile launcher, a liquid sprayer, an air blower, a flame thrower, a heat projector, a cold projector, a scent projector, a chemical projector, an electric discharge device, a grasping device, a moveable and/or articulating arm, a hand, object manipulation devices, a fire extinguisher, a screwdriver, a hammer, a wrench, a welder, a saw, a knife, a pick, a prod, a vacuum device, a suction device, a sander, a laser, and/or any suitable tools to perform any task. Additionally, the instruments 918 can include one or more indicator devices, non-limiting examples of which can include, a light, a signal light, a light pattern, a display screen, an audio speaker, and/or any other suitable indicator device. The drone device 900 can further include a device bus 914 that couples the various components of the drone device 900, including but not limited to, the navigation component 902, the access component 904, the scheduling component 910, the package localization component 912, the communication component 916, the instruments 918, the processor 920 and the memory 922.

The navigation component 902 can be configured to facilitate navigating the drone device 900 to a package delivery and pick up locations. In this regard, the navigation component 902 can provide an auto-pilot functionality of the drone device 900 and facilitate automatically flying the drone device 900 to protected areas (e.g., protected area 106) where the done device is scheduled to drop off and/or pick up a package. For example, the navigation component 902 can receive or access delivery information that identifies or indicates specific physical location of the protected areas where the drone device 900 is scheduled to drop off or pick up package. For instance, the delivery information can include a physical address of a protected area, a coordinate location of the protected area, or the like. In the embodiment shown, the delivery information 924 can be stored in the local memory 922 of the drone device. In some embodiments, in addition to identifying a location of a protected area for dropping off or picking up a package, the drone delivery information can include various additional types of information that can be employed by the drone device 900 to facilitate delivering and/or picking up packages. For example, the additional information can include but is not limited to, authorization information that can be employed by the drone device to receive access to a protected area (e.g., an access code, a secret password, a secret key, etc.), information regarding restrictions or parameters associated with receiving access (e.g., date, time, time window, etc. for delivering or picking up a package), tracking information, and the like.

In various embodiments, the delivery information 924 can be accessed and/or retrieved from an external drone delivery server device 602 (e.g., from the delivery information 416). In this regard, the delivery information 924 can include relevant delivery information pertaining to packages that the drone device 900 is scheduled to deliver and/or pick up. With these embodiments, the scheduling component 910 can facilitate accessing and/or retrieving the relevant delivery information for the drone device 900 from the drone delivery server device 602. For example, in some implementations, in association with picking up a package for delivery, either at a warehouse, a private residence, a commercial location or the like, the drone device 900 can be configured to receive information that uniquely identifies the package and/or the scheduled delivery event, such as a tracking number or the like. For instance, the package can include a label with a barcode, QR code or the like, that can be scanned by the drone device 900 to retrieve the corresponding tracking number. Using the extracted tracking number, the scheduling component 910 can access the delivery information 604 at the drone delivery server device 602 to look up the delivery information associated with the package, including but not limited to, information identifying the specific location or protected area for dropping off the package, authorization information needed for access to the protected area, restrictions associated with delivery, and the like.

The access component 904 can be configured to facilitate receiving access, by the drone device 900, to a protected area for delivering and/or picking up a package by facilitating removal of the physical barrier 108. In the embodiment shown, the access component 904 can include signaling component 906 and request component 908. In some implementations, the signaling component 906 can be configured to emit (or direct the communication component 916 to emit) a notification signal or beacon indicating the drone device 900 has a package for delivery at a protected area 106 or indicating the drone device is scheduled to pick up the package at the protected area 106. According to these implementations, the drone device 900 can be configured to receive the access to the protected area via the removed physical barrier 108 based on reception of the notification signal by the local M2M management device 112 at the protected area. For example, the local M2M management device 112 can be configured to control the removal of the physical barrier based on the reception of the notification signal.

In some embodiments, the notification signal can include a universal signal that can be emitted by all delivery drones and interpreted by any local M2M management device at any protected area as an indication that a drone device has a package for delivery or pick up. In other embodiments, the notification signal can be tailored to the particular drone device, the M2M management device/protected area, and/or the particular delivery event. For example, in one embodiment, the drone device 900 can be configured to transmit a defined notification signal that uniquely identifies the drone device 900 and indicates the drone device is requesting access to a protected area 106 to deliver or pick up a package. According to this embodiment, the local M2M management device at the protected area can be configured to listen for the unique signal and provide the drone device access to the protected area based on detection of the unique signal. The local M2M management device can deny access to other drone devices that do not emit the unique signal. In another embodiment, the signaling component 906 can have access to information (e.g., included in the delivery information 924 and/or the delivery information 604 provided at the drone delivery server device 602) that identifies a unique notification signal employed by each local M2M management device 112 at each protected area 106. According to this embodiment, when attempting to receive access to a particular protected area, the signaling component 906 can direct the communication component 916 to emit or transmit the particular notification signal employed by the particular local M2M management device 112 at the particular protected area. The local M2M management device 112 can further only allow the drone devices that provide particular notification signal access to the protected area.

In some embodiments, the drone device 900 can be configured to receive access to a protected area 106 for delivering or picking up a package based on submission of a request to the local M2M management device 112 at the protected area 106. According to these embodiments, in association with arrival and/or approach of the drone device 900 to the protected area 106, the request component 908 configured to send an access request to a local M2M management device 112 at the protected area requesting access to the protected area. The local M2M management device 112 can further be configured to control the removal and reapplication of the physical barrier 108 based on reception of the access request. Further, in implementation in which the local M2M management device 112 is configured to provide the drone device access only at a particular scheduled time or time window, the request component 908 can be configured to request access at the particular scheduled time or time window. Otherwise, access request received outside of the particular scheduled time or time window can be denied by the local M2M management device 112.

In various embodiments, in order to increase security association with providing drones access to protected areas 106 for package delivery and/or pick up, the local M2M management device 112 can apply a suitable verification/authentication procedure to ensure a drone requesting access is authorized to receive access prior to providing the drone access to the protected area 106. With these embodiments, the request component 908 can be configured to include or provide authorization information for the drone device with submission of the access request and the local M2M management device 112 can be configured to control the removal of the physical barrier based on a determination that the authorization information is valid. For example, as discussed supra with respect to the authorization component 407, the authorization information can include but is not limited to, a unique identifier for the drone device, a secret key, a password, an access code or the like.

The package localization component 912 can be configured to facilitate identifying a location within a protected area to drop off or pick up a package. For example, as described with reference to FIG. 8, in some embodiments, the drone device can be configured to look for defined visual markers provided within the protected area 106 and/or on packages for pick up, to facilitate identifying a designated package drop off or pick up location. With these embodiments, the package localization component 912 can be configured to facilitate identifying the designated location based on recognition of one or more visual markers in image data captured via one or more cameras of the drone device. In other embodiments, the package localization component 912 can be configured to detect a signal or beacon provided at a package drop off or pick up location and direct the drone device to position itself at or near the beacon.

While FIGS. 4, 7 and 9 depict separate components, it is to be appreciated that two or more components can be implemented in a common component. Further, it is to be appreciated that the design of the local M2M management device 112 and/or the drone devices described herein (e.g., drone device 102, 202, 302, and 802) can include other component selections and/or component placements to facilitate the various drone package delivery applications described herein. Moreover, the aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components can be combined into a single component providing aggregate functionality. The components can also interact with one or more other components not specifically described herein for the sake of brevity, but known by those of skill in the art.

Further, some of the processes performed may be performed by specialized computers for carrying out defined tasks related to drone delivery and landing. The subject computer processing systems, methods apparatuses and/or computer program products can be employed to solve new problems that arise through advancements in technology, computer networks, the Internet and the like. The subject computer processing systems, methods apparatuses and/or computer program products can provide technical improvements to systems for automated package delivery and pick up using drones in residential and commercial settings.

The embodiments of devices described herein can employ artificial intelligence (AI) to facilitate automating one or more features described herein. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect) described herein, components described herein can examine the entirety or a subset of the data to which it is granted access and can provide for reasoning about or determine states of the system, environment, etc. from a set of observations as captured via events and/or data. Determinations can be employed to identify a specific context or action, and/or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determination.

A classifier can map an input attribute vector, z=(z1, z2, z3, z4, zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

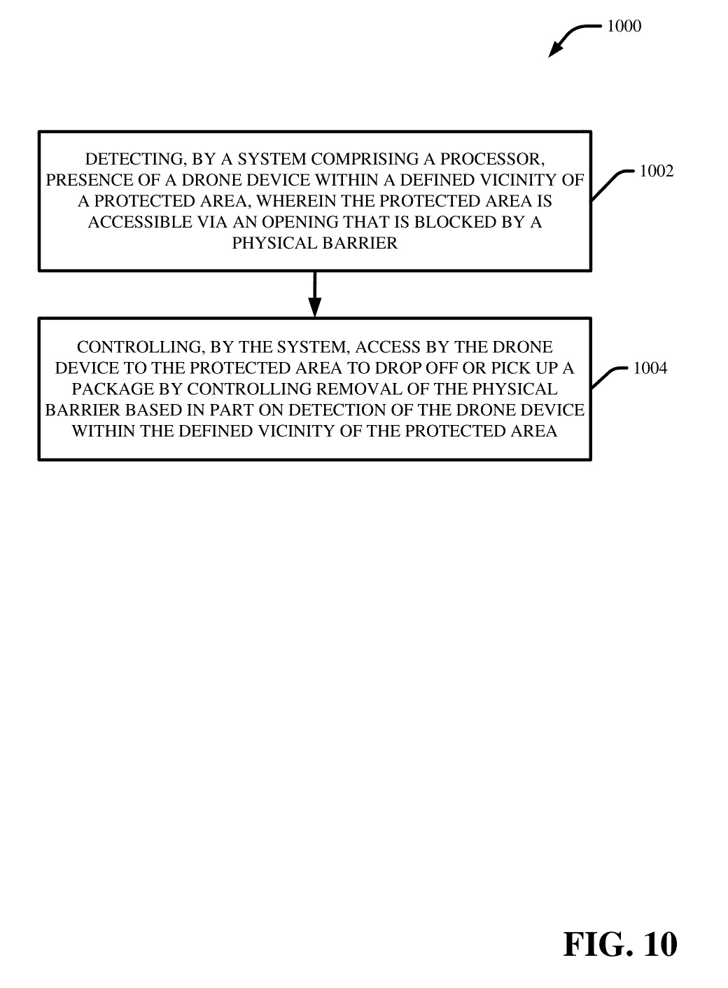

FIG. 10 illustrates a flow diagram of an example, non-limiting computer-implemented method 1000 that facilitates drone delivery and landing in accordance with one or more embodiments described herein. Repetitive description of like elements employed in respective embodiments is omitted for sake of brevity.

At 1002, a system comprising a processor (e.g., the local M2M management device 112 and/or the subsystem 116), detects presence of a drone device (e.g., drone device 102) within a defined vicinity of a protected area (e.g., protected area 106), wherein the protected area is accessible via an opening that is blocked by a physical barrier (e.g., physical barrier 108). At 1004, the system controls access by the drone device to the protected area to drop off or pick up a package by controlling (e.g., using access control component 404) removal of the physical barrier based in part on detection of the drone device within the defined vicinity of the protected area.

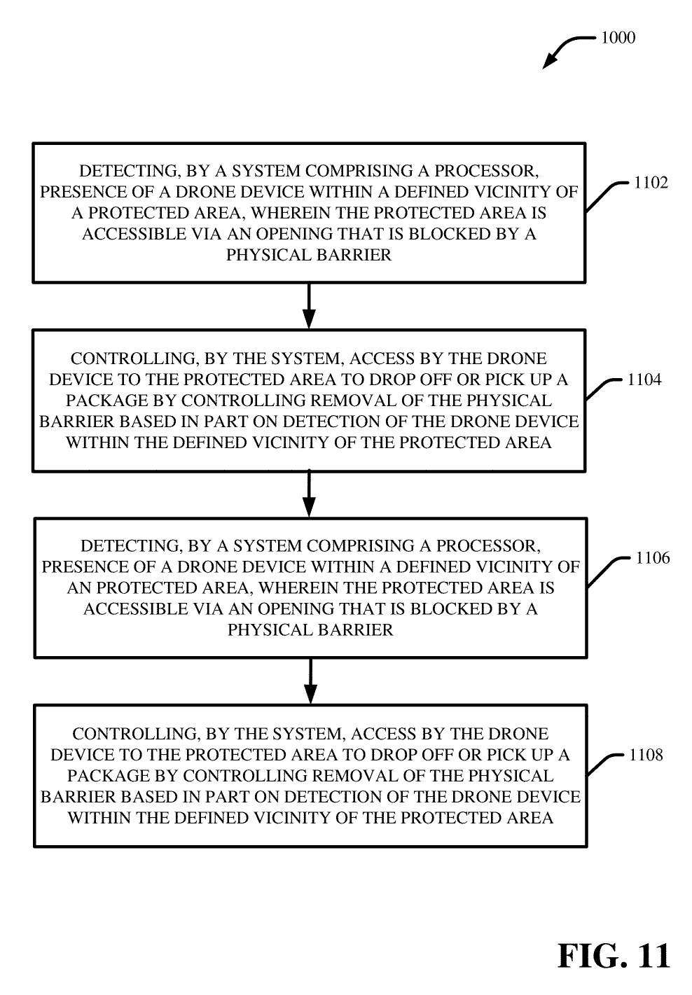

FIG. 11 illustrates a flow diagram of another example, non-limiting computer-implemented method 1100 that facilitates drone delivery and landing in accordance with one or more embodiments described herein. Repetitive description of like elements employed in respective embodiments is omitted for sake of brevity.

At 1102, a system comprising a processor (e.g., the local M2M management device 112 and/or the subsystem 116), detects presence of a drone device (e.g., drone device 102) within a defined vicinity of a protected area (e.g., protected area 106), wherein the protected area is accessible via an opening that is blocked by a physical barrier (e.g., physical barrier 108). At 1104, the system controls access by the drone device to the protected area to drop off or pick up a package by controlling (e.g., using access control component 404) removal of the physical barrier based in part on detection of the drone device within the defined vicinity of the protected area. At 1106, the system receives a request from the drone device to access the protected area, the request comprising authorization information for the drone device. At 1108, the system provides the drone device the access to the protected area by controlling the removal of the physical barrier based on a determination that the authorization information is valid (e.g., via authorization component 406).

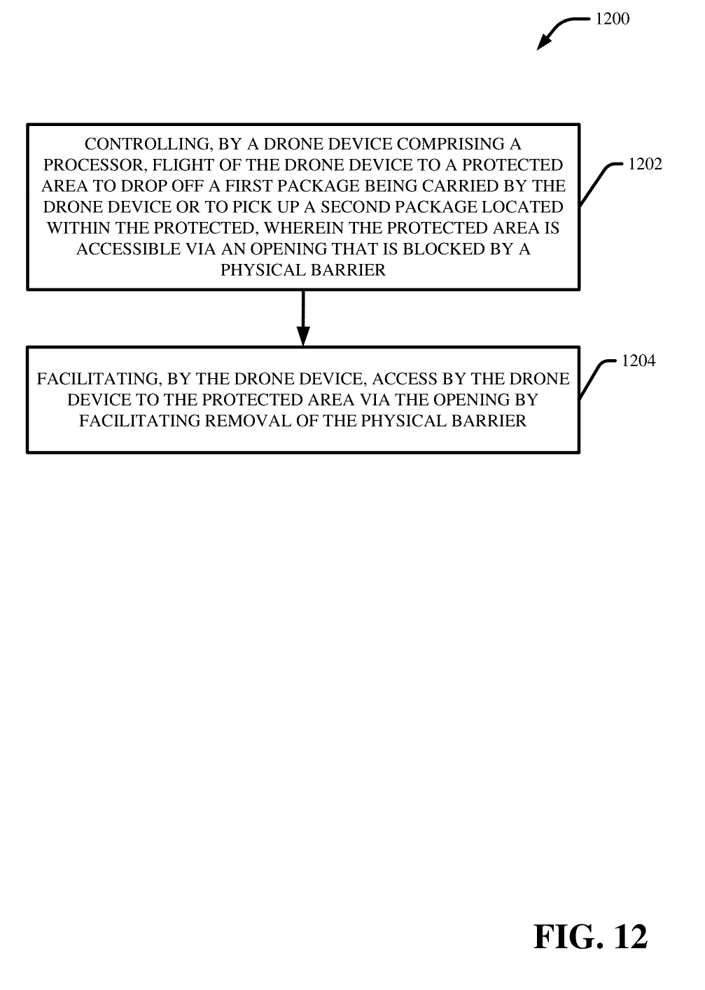

FIG. 12 illustrates a flow diagram of another example, non-limiting computer-implemented method 1200 that facilitates drone delivery and landing in accordance with one or more embodiments described herein. Repetitive description of like elements employed in respective embodiments is omitted for sake of brevity.

At 1202, a drone device comprising a processor (e.g., drone device 900 and the like), controls flight of the drone device (e.g., via navigation component 902) to a protected area to drop off a first package being carried by the drone device or to pick up a second package located within the protected, wherein the protected area is accessible via an opening that is blocked by a physical barrier. At 1204, the drone device facilitates access, by the drone device, to the protected area via the opening by facilitating removal of the physical barrier 1204 (e.g., via access component 904).

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

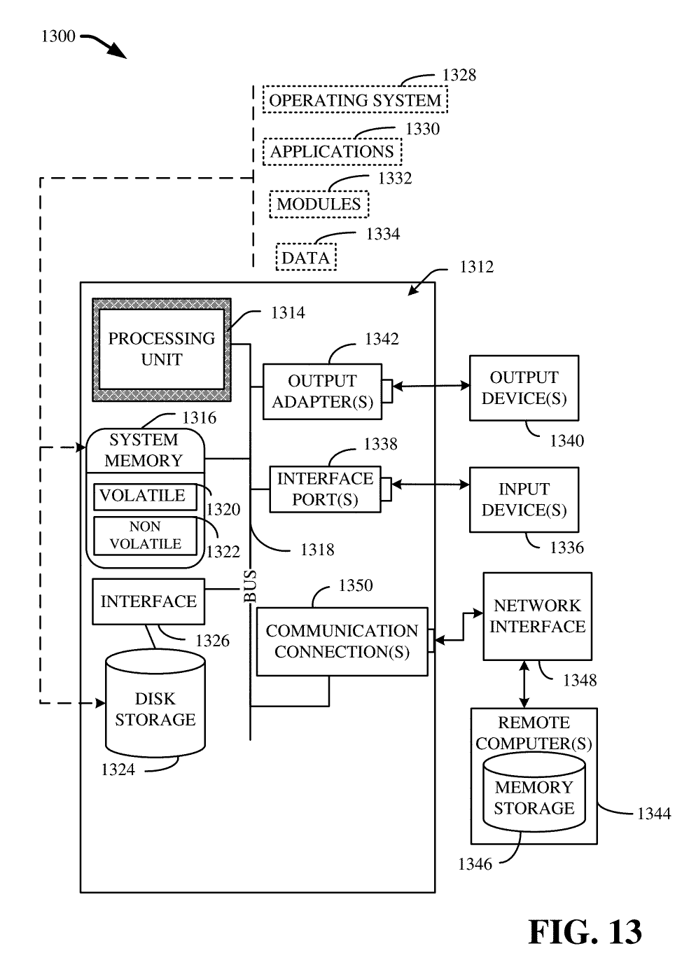

In order to provide a context for the various aspects of the disclosed subject matter, FIG. 13 as well as the following discussion are intended to provide a general description of a suitable environment in which the various aspects of the disclosed subject matter can be implemented. FIG. 13 illustrates a block diagram of an example, non-limiting operating environment in which one or more embodiments described herein can be facilitated. Repetitive description of like elements employed in other embodiments described herein is omitted for sake of brevity. With reference to FIG. 13, a suitable operating environment 1300 for implementing various aspects of this disclosure can also include a computer 1312. The computer 1312 can also include a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314. The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI). The system memory 1316 can also include volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1320 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1312 can also include removable/non-removable, volatile/nonvolatile computer storage media. FIG. 13 illustrates, for example, a disk storage 1324. Disk storage 1324 can also include, but is not limited to, devices like a magnetic disk drive, floppy disk drive, tape drive, Jaz drive, Zip drive, LS-100 drive, flash memory card, or memory stick. The disk storage 1324 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1324 to the system bus 1318, a removable or non-removable interface is typically used, such as interface 1326. FIG. 13 also depicts software that acts as an intermediary between users and the basic computer resources described in the suitable operating environment 1301. Such software can also include, for example, an operating system 1328. Operating system 1328, which can be stored on disk storage 1324, acts to control and allocate resources of the computer 1312. System applications 1330 take advantage of the management of resources by operating system 1328 through program modules 1332 and program data 1334, e.g., stored either in system memory 1316 or on disk storage 1324. It is to be appreciated that this disclosure can be implemented with various operating systems or combinations of operating systems. A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port can be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a computer, a server, a router, a network PC, a workstation, a microprocessor based appliance, a peer device or other common network node and the like, and typically can also include many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1350 refers to the hardware/software employed to connect the network interface 1348 to the system bus 1318. While communication connection 1350 is shown for illustrative clarity inside computer 1312, it can also be external to computer 1312. The hardware/software for connection to the network interface 1348 can also include, for exemplary purposes only, internal and external technologies such as, modems including regular telephone grade modems, cable modems and DSL modems, ISDN adapters, and Ethernet cards.

Embodiments of the present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
a drone detection component configured to detect presence of a drone device within a defined vicinity of a protected area, wherein the protected area is accessible via an opening that is blocked by a physical barrier; and
an access control component configured to control access, by the drone device to the protected area via the opening by controlling removal of the physical barrier based in part on detection of the drone device within the defined vicinity of the protected area.

2. The system of claim 1, wherein the physical barrier comprises a door or gate and wherein the access control component is configured to control the access by the drone device to the protected area by controlling opening and closing of the door or gate.

3. The system of claim 1, wherein the drone detection component is configured to detect the presence of the drone device based on reception of a defined signal transmitted by the drone device.

4. The system of claim 3, wherein the defined signal comprises or corresponds to authorization information for the drone device, and wherein the computer executable components further comprise:
an authorization component configured to determine whether the drone device is authorized to receive the access the protected area based on the authorization information, and direct the access control component to cause the removal of the physical barrier based on a determination that the drone device is authorized to receive the access the protected area.

5. The system of claim 1, wherein the access control component is configured to receive a request from the drone device requesting the access to the protected area, the request comprising authorization information for the drone device, and wherein the computer executable components further comprise:
an authorization component configured to determine whether the drone device is authorized to receive the access the protected area based on the authorization information, and direct the access control component to cause the removal of the physical barrier based on a determination that the drone device is authorized to receive the access the protected area.

6. The system of claim 1, wherein the drone detection component is configured to detect the presence of the drone device using one or more sensor devices of the system.

7. The system of claim 6, wherein the one or more sensor devices are selected from the group consisting of: an optical sensor, an acoustic sensor, a motion sensor, and an electromagnetic sensor.

8. The system of claim 1, wherein the access control component is further configured to control the access by the drone device to the protected area via the opening by controlling the removal of the physical barrier for a defined period of time after the detection of the drone device within the defined vicinity of the protected area, wherein after passage of the defined period of time, the access control component is configured to cause re-application of the physical barrier.

9. The system of claim 1, wherein the access control component is further configured to control the access by the drone device to the protected area via the opening by controlling the removal of the physical barrier based in part on a time of the detection of the drone device within the defined vicinity of the protected area.

10. The system of claim 1, wherein the computer executable components further comprise:
a package directing component configured to facilitate directing the drone device to a defined location within the protected area, wherein the defined location comprises a drop off location at which the drone device is configured to drop off a first package that is being delivered by the drone device, or a pick up location at which the drone device is configured to pick up a second package for delivery by the drone device.

11. A drone device, comprising:
a package carrying apparatus configured to carry a package;
a memory that stores computer executable components; and
a processor that executes the computer executable components stored in the memory, wherein the computer executable components comprise:
a navigation component configured to control flight of the drone device to a protected area, wherein the protected area is accessible via an opening that is blocked by a physical barrier; and
an access component configured to facilitate access by the drone device to the protected area via the opening to drop off the package or pick up the package by facilitating removal of the physical barrier.

12. The drone device of claim 11, wherein the access component comprises:
a signaling component configured to emit a notification signal indicating the drone device has the package for delivery at the protected area or indicating the drone device is scheduled to pick up the package at the protected area, wherein the drone device is configured to receive the access to the protected area via the opening based on reception of the notification signal by a management device at the protected area.

13. The drone device of claim 12, wherein the management device is configured to control the removal of the physical barrier based on the reception of the notification signal.

14. The drone device of claim 11, wherein the access component comprises:
a request component configured to send an access request to a management device at the protected area, the access request requesting access to the protected area, wherein the management device is configured to control the removal and reapplication of the physical barrier based on reception of the access request.

15. The drone device of claim 14, wherein the management device is further configured to control the removal and the reapplication of the physical barrier based on the reception of the access request at a defined time or within a defined window of time.

16. The drone device of claim 14, where the access request comprises authorization information for the drone device and wherein the management device is configured to control the removal of the physical barrier based on a determination that the authorization information is valid.

17. The drone device of claim 11, wherein the computer executable components comprise:
a package localization component configured to facilitate identifying a location within the protected area to drop of the package or pick up the package.

18. The drone device of claim 17, wherein the package localization component is configured to facilitate identifying the location based on recognition of one or more visual markers in image data captured via a camera of the drone device.

19. A computer-implemented method, comprising:
detecting, by a system comprising a processor, presence of a drone device within a defined vicinity of a protected area, wherein the protected area is accessible via an opening that is blocked by a physical barrier; and
controlling, by the system, access by the drone device to the protected area to drop off or pick up a package by controlling removal of the physical barrier based in part on detection of the drone device within the defined vicinity of the protected area.

20. The computer-implemented method of claim 19, further comprising:
receiving, by the system, a request from the drone device to access the protected area, the request comprising authorization information for the drone device; and
providing, by the system, the drone device the access to the protected area by controlling the removal of the physical barrier based on a determination that the authorization information is valid.
